(19) United States
(12) Patent Application Publication
(10) Pub. No.: US 2002/0186730 A1
(43) Pub. Date: Dec. 12, 2002

(54) Integrated multiple wavelength pump laser module

(76) Inventor: Dmitri Zalmanovitch Garbuzov, Princeton, NJ (US)

Correspondence Address: DUANE MORRIS LLP, 100 COLLEGE ROAD WEST, SUITE 100, PRINCETON, NJ, 08540-6604, US

(21) Appl. No.: 09/954,794

(22) Filed: Sep. 17, 2001

Related U.S. Application Data
(60) Provisional application No. 60/296,799, filed on Jun. 8, 2001.

(51) Int. Cl. H01S 3/04; H01S 3/091; H01S 3/094

(52) U.S. Cl. 372/36; 372/75

(57) ABSTRACT

An integrated multiple-wavelength semiconductor pump laser module operable to generate a plurality of optical wavelength outputs on a single fiber comprising a base layer containing a multi-wavelength laser array and a wavelength multiplexer or combiner unit to produce a single output from a plurality of laser wavelengths. The laser array is operable to emit a plurality of wavelengths and each of the laser outputs is substantially oppositely opposed and proximately located to a corresponding combiner input such that laser output enters the combiner input without the use of optical fibers. In one aspect of the invention, the laser array is composed of individual high power DFB lasers. In a second aspect of the invention, the laser array is composed of a single material containing a plurality of lasers fabricated by altering the quantum well widths within the material. In a third aspect of the invention, the laser array and combiner unit are concurrently fabricated within a base layer of semiconductor material.

### BENEFIT OF PRIORITY FILING DATE

This application claims the benefit under 35 U.S.C. §119 of the earlier filing date of provisional application serial No. ______, entitled “Integrated Multiple Wavelength Laser Pump Module, ” filed on Jun. 8, 2001.

### FIELD OF THE INVENTION

This invention is related to optical components. More specifically, this invention is directed to an integrated multiple wavelength semiconductor pump laser module.

### BACKGROUND OF THE INVENTION

The use of optical amplifiers to increase the signal strength of a transmitted signal is well known in fiber optic communication systems. Erbium Doped Fiber Amplifiers (EDFA), such as the illustrative example shown in FIG. 1, are commonly used to increase the amplitude of an input signal by transferring photonic energy from each of the illustrated pumping lasers to the input signal. In the illustrative example, input signal 110 is amplified in an initial stage 112 using a first pump laser 114, which is coupled to the fiber through coupler 116. Pump laser 114 typical is a 980-nm Fabry-Perot semiconductor laser, which allows a large signal gain without introducing significant amounts of noise. Isolator 118 and dispersion compensating fiber 120 are used to reduce the reflection of optical signal 110 back into initial stage 112. Input signal 110 is then successively amplified, using pump lasers, 120a, 120b, 120c, which are coupled into the optical fiber signal path using couplers 122a, 122b respectively. Pump lasers 120a, 120b, 120c, typically are 1480-nm Febry-Perot semiconductor lasers, as this wavelength offers more-efficient pumping, in the form of lower cost per milliwatt (mW) output.

A second common optical amplifier is a Raman amplifier, which is generally used in larger bandwidth Dense Wave Division Multiplex (WDM) systems. Generally, DWDM carrier signal wavelengths are separated by a minimum acceptable wavelength separation to increase the number of carrier wavelengths that can be included in the transmission signal and Raman amplifiers are useful because they have a flat gain across the bandwidth of the transmitted signals. A conventional Raman amplifier is illustrated in FIG. 2. In this illustrative example, a plurality of carrier signals 202a, through 202n, typically generated by corresponding low-power Distributed FeedBack (DFB) lasers, are combined by multiplexer 205 into DWDM optical signal 210 and transmitted along transmission fiber 215. DWDM signal 210 is amplified by broadband amplifier 220, which is pumped using the output of combiner 230. As shown the output of combiner 230 is a combination of pump lasers 212a, 212b, 212c and 212d. In this case, the outputs of pump lasers 212a and 212b are combined into a first signal and the outputs of pump lasers 212c and 212d are also combined into a second signal. The combined first and second outputs are then combined into a single output representative of the output of combiner 230. Isolator 235 prevents reflections of the combined signal from being reflected back into combiner 230.

FIG. 3 illustrates a 12-wavelength-channel WDM high power monolithic pump laser diode unit 300, which is more fully disclosed in the article entitled “100 nm Bandwidth Flat-Gain Raman Amplifiers Pumped and Gain-Equalised by 12-Wavelength-Channel WDM Laser Diode Unit” by Y. Emori, K. Tanaka, and S. Namiki, IEE Electronics Letter Online, Apr. 15, 1999. In this illustrated WDM pump laser diode unit, 24 diode lasers, 302a through 302x, are paired into 12 channels. For each channel there is an associated polarization beam combiner (PSB) 304a through 304n, which is used as a polarization multiplexer of the laser diodes for a particular channel. Coupler 310 is representative of a conventional opto-electronic or electro-optic material, such as silicon, silicon oxide, that includes 11 Mach-Zehnder interferometers (MZIs). Mach-Zehnder interferometers are well known in the art and are useful as wavelength multiplexers (WM) as they exhibit little reflection from one waveguide channel to another. Directional couples are also used as wavelength multiplexers. In this illustrative example, in a first stage alternate channels, e.g., channel 1 and channel 2, and channel 3 and channel 4, etc., are successively combined using an associated MZI. In a next stage, the combined output of channels 1 and 2 are combined with the combined outputs of channels 3 and 4 etc. The channels are successively combined until a single combined output is obtained.

Generally, Fabry-Perot (FP) lasers are used as pump lasers as they are capable of high power operation by increasing the laser drive current. However, the high power spectrum of a FP laser is known to be several nanometers wide and increases as the laser drive current increases. For single wavelength transmission or pump systems, the power spectrum of the Fabry-Perot laser is tolerable. However, for WDM transmission or multi-wavelength pump systems, where a separation of channel frequencies is needed, the power spectrum of FP lasers becomes increasingly unacceptable.

To correct for the wide spectrum of FP lasers, special optical fibers, which contain Bragg Gratings, referred to as Fiber Bragg Grating (FBG) fibers are used to convert the broad spectrum of the conventional Fabry-Perot laser into a narrow wavelength signal. FBG fibers are illustrated in FIG. 3 as elements 306a through 306n. Even in single frequency pump systems, FBG fibers are used to stabilize the spectrum of the pump laser.

However, the use of FBG fibers and FBG stabilized lasers has significant disadvantageous. The fibers are expensive to manufacture, must be custom matched to the desired laser diode wavelength and their use reduces the output signal power of the combined device by up to 15 percent. Further, FBG lasers include several meters of fiber, which must be combined in a single multiplexer unit, which is in the order of 10-20 centimeters long. Hence, a single pump module with a multi-wavelength output cannot be fabricated using current FBG technology. Accordingly, removing the need for FBG fibers is important in the field of optical components. One method of removing FBG fibers is to integrate a semiconductor laser and wavelength multiplexer onto a base material. An example of such integration is depicted in U.S. Pat. No. 6,208,454 to Koren, et al., issued Mar. 27, 2001, entitled, “All-Optical Mach-Zehnder Wavelength Converter with Monolithically Integrated Laser.” In this example, an integrated wavelength converter is depicted wherein a DFB laser is coupled to a Mach-Zehnder Interferometer (MZI). However, these integrated packages are generally limited to transmission type lasers, as transmission lasers are typically low power.

Hence, there is a need for an integrated multi-wavelength pump laser module that generates a plurality of high power wavelengths.

### SUMMARY OF THE INVENTION

An integrated multi-wavelength laser pump module operable to combine a plurality of optical wavelengths onto a single waveguide output is disclosed. In a first embodiment, the integrated pump laser module comprises, a base layer having a first surface and a second surface and at least one substantially perpendicular surface, e.g., a step, therebetween, a plurality of waveguides fabricated in the semiconductor base layer which are coupled in a manner to produce a single waveguide output. Each waveguide has an input end on the vertical surface. A semiconductor laser array located on the first surface containing at least one active region operable to emit a plurality of narrow spectra wavelengths and proximately located to the vertical surface containing the waveguide inputs, wherein each the laser active region is substantially oppositely opposed to a corresponding waveguide input end. In a second embodiment, the laser array and wavelength multiplexer are integrally fabricated within an electro-optical material such that each of the laser array active region is substantially adjacent to and oppositely opposing a corresponding WM waveguide.

### BRIEF DESCRIPTION OF THE FIGURES

FIG. 1 illustrates a block diagram of a conventional Erbium Doped Fiber Amplifier;

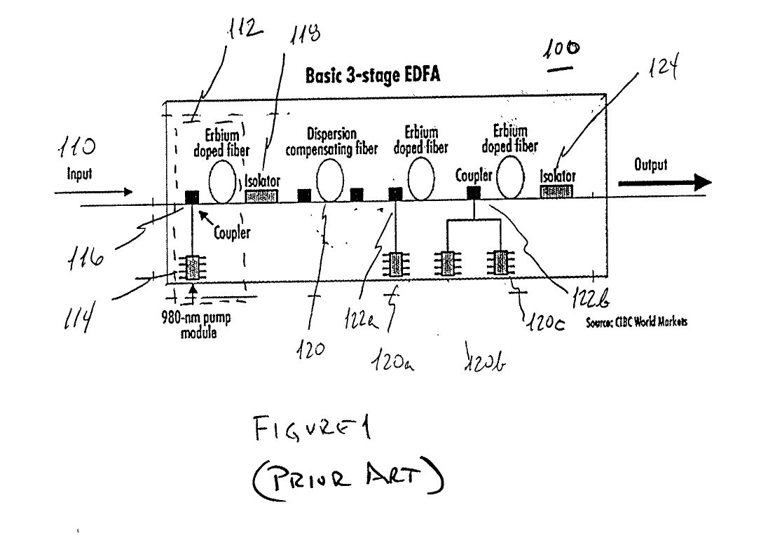

FIG. 2 illustrates a block diagram of a conventional Raman Amplifier;

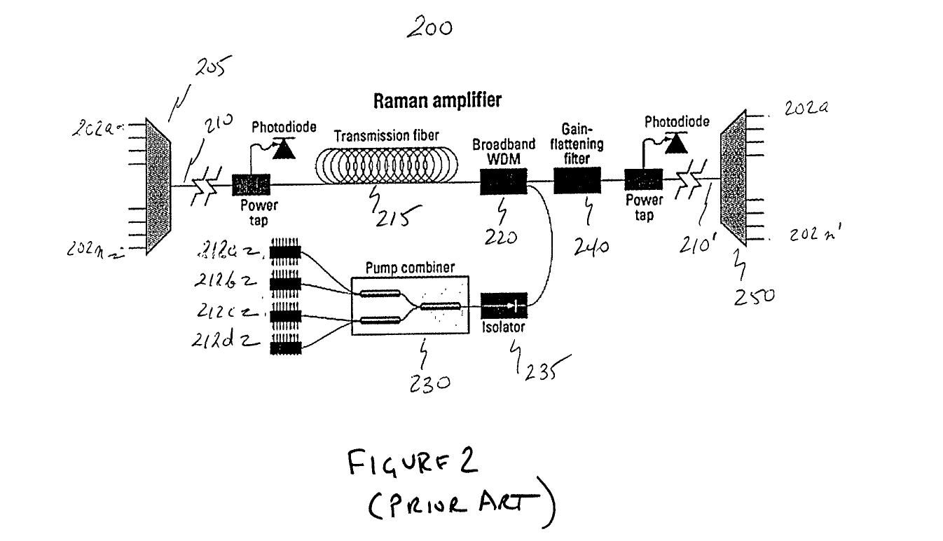

FIG. 3 illustrates a block diagram of a conventional multiple wavelength combiner;

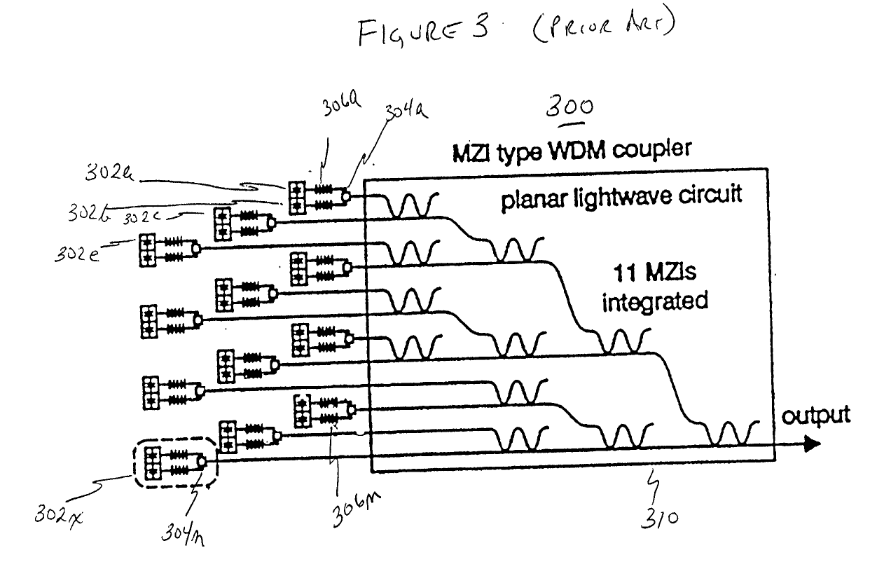

FIG. 4 illustrates a top view of an exemplary integrated multiple wavelength laser pump module in accordance with the principles of the invention;

FIG. 5 illustrates a perspective view of an exemplary multiple wavelength laser pump module in accordance with the principles of the invention;

FIG. 6 illustrates a cross-sectional view of an exemplary integrated multiple wavelength laser pump module in accordance with one aspect of the invention;

FIG. 7 illustrates a top view of an exemplary integrated multiple wavelength laser pump module in accordance with another aspect of the present invention;

FIG. 8 illustrates a cross-sectional view of an exemplary embodiment of an integrated laser pump in accordance with still another embodiment of the invention; and

FIG. 9 illustrates a top view of the embodiment of the invention illustrated in FIG. 8.

It is to be understood that these drawings are solely for purposes of illustrating the concepts of the invention and are not intended as a level of the limits of the invention. It will be appreciated that the same reference numerals, possibly supplemented with reference characters where appropriate, have been used throughout to identify corresponding parts.

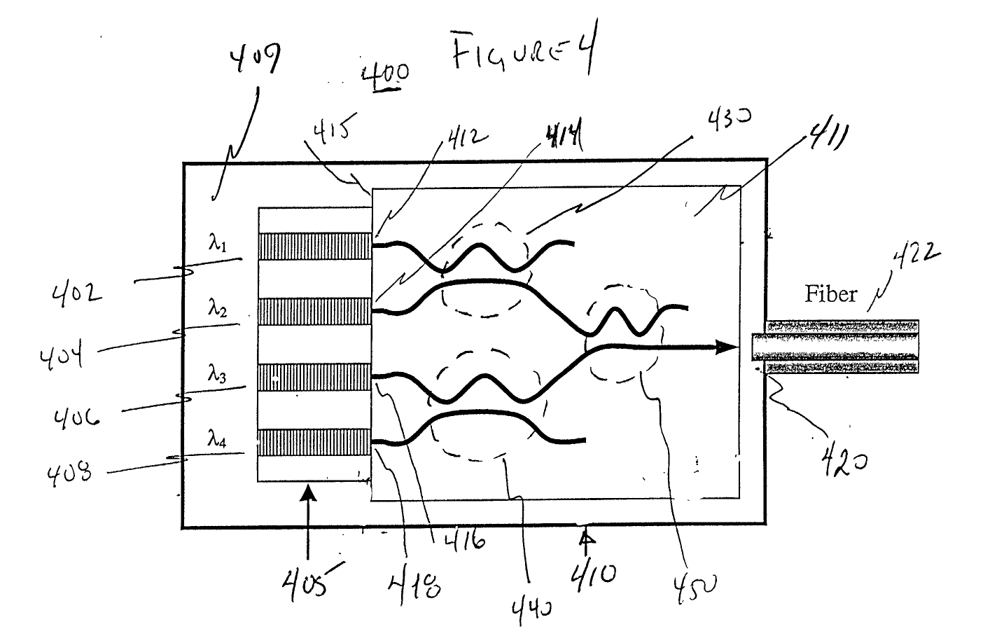

Referring now to FIG. 4, there is depicted a cross-sectional top view of an exemplary embodiment of an integrated multiple wavelength laser pump module 400 in accordance with the present invention. In this embodiment of the invention, a planar lightwave circuit includes a pump laser package 405, shown as emitting four wavelengths, 402, 404, 406, 408, proximately located or juxtaposed to optical combiner element 411. In this illustrated embodiment, MW 411 includes four Mach-Zehnder Interferometers (MZI) waveguide channels, 412, 414, 416, 418. However, it would be appreciated that any wavelength multiplexer, such as directional couplers, may be used as combiner element 411. Mach-Zehnder Interferometer (MZI) and directional couplers are well known in the art and are useful as filters or multiplexers/demultiplexers. In this illustrative example, wavelength λ1, emitted from laser 402, or more precisely the active region corresponding to laser 402, is applied to channel 1 input port, represented as 412, of combiner 411. Similarly, wavelength λ2, emitted from laser element 404, or the active region corresponding to laser 404, is applied to channel 2 input port, represented as 414, of combiner 411. Further, in this illustrative example, wavelength λ3, emitted from the active region of laser element 406 is applied to channel 3 input port, represented as 416, of combiner 411 and wavelength λ4, emitted from the active region of laser element 408 is applied to channel 4 input port, represented as 418, of combiner 411. The inputted wavelengths λ₁ and λ₂ and λ₃ and λ₄ are first combined together, using optical combiners 430 and 440, respectively, and the combined outputs of λ₁ and λ₂, i.e., channels 1 and 2, and λ₃ and λ₄, i.e., channels 3 and 4, are then combined using optical combiner 450. The output at port 420 of combiner 411, which is placed onto fiber 422, in this example, is a combined signal consisting of wavelengths λ₁, λ₂, λ₃ and λ₄. The use of MZI for optical combining is well-known in the art and need not be discussed in detail herein.

In a preferred mode of high power operation, at least one Distributed Feedback Laser (DFB) as disclosed in commonly assigned PCT patent application serial number US01/02019, entitled “High Power Distributed Feedback Ridge Waveguide Laser,” filed on Jan. 22, 2001, and which is incorporated herein by reference, is incorporated into laser array 405. In one aspect of the invention, laser elements may be individually placed onto first surface 409. In still another aspect, and a preferred mode, of the invention, a plurality of laser elements are fabricated within a single semiconductor material. In this aspect of the invention, the laser elements are fabricated with a quantum wells of differing widths which then generate laser light at a different wavelength. A monolithic multi-wavelength laser diode array is advantageous in allowing for the accurate positioning of each laser active region with respect to each of the input waveguide ports of combiner 411.

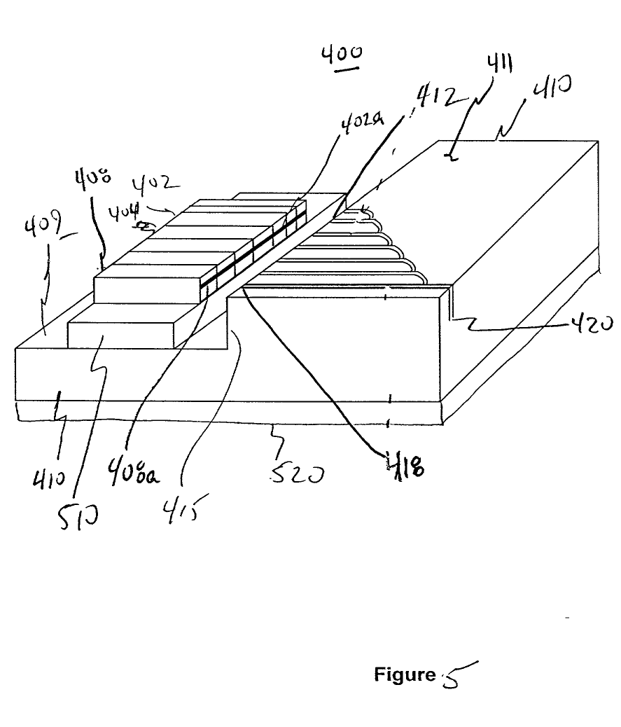

FIG. 5 illustrates a perspective view of an integrated multiple wavelength laser pump module 400 in accordance with the principles of the invention. In this aspect of the invention, module 400 has a base layer or platform 410 which consists of a first surface 409 and a second surface 410 that are separated by a substantially perpendicular surface 415. Hence, in this aspect of the invention first surface 409 and second surface 410 are in a step relation. Materials of base layer or platform 410 are preferably selected from a group of materials that have a high thermal conductivity, such as silicon,(Si), aluminum nitrate (AlN), gallium arsinide (GaAs), indium phosphate (InP). In one aspect of the invention, laser diodes 402, 404, etc., are positioned onto first surface 409 such that the corresponding active regions are substantially oppositely opposed to corresponding waveguide entry port elements 412, 414 located on the substantially perpendicular surface 415 between first surface 409 and second surface 410. Although the illustrated waveguide elements are depicted on second surface, it would be understood that this is merely a representation to show the waveguides are interconnected to single output port 420. It will be understood by those skilled in the art that the waveguide elements are contained within the base layer material 410 and that each waveguide has an entry port (not shown) located on substantially perpendicular surface 415. Preferably, materials base layer 410 are selected such that the thermal coefficient of expansion is close to the material selected for laser elements 402, 404, etc.

Further illustrated are laser diode active regions, represented as 402a, 408a, corresponding to illustrated lasers 402, 408, which are oppositely opposed to surface 415 and proximately located to a corresponding waveguide entry port (not shown). Laser diode array 405 is preferable positioned within a range of 3 to 5 microns from a corresponding waveguide entry port.

In one aspect of the invention, and that illustrated, laser diode array 405 may be bonded with a bonding material 510 that has a good thermal conductive property, such as gold tin (AuSn), indium (In), lead tin (PbSn), etc. Bonding material 510 is then bonded onto first surface 409. In another aspect, integrated multiple wavelength pump module 400 can be placed or fabricated or deposited onto, a thermal-electrical cooler (TEM) element 520. Thermal cooler element 520 is useful in removing heat from laser diode array 405.

The use of a single thermal-electrical cooler element for a plurality of laser diode elements is advantageous as the need for individual thermal coolers, as is done in conventional pump laser technology, is removed. Accordingly, the instant invention further decreases the cost of manufacturing and size of the overall pump laser module.

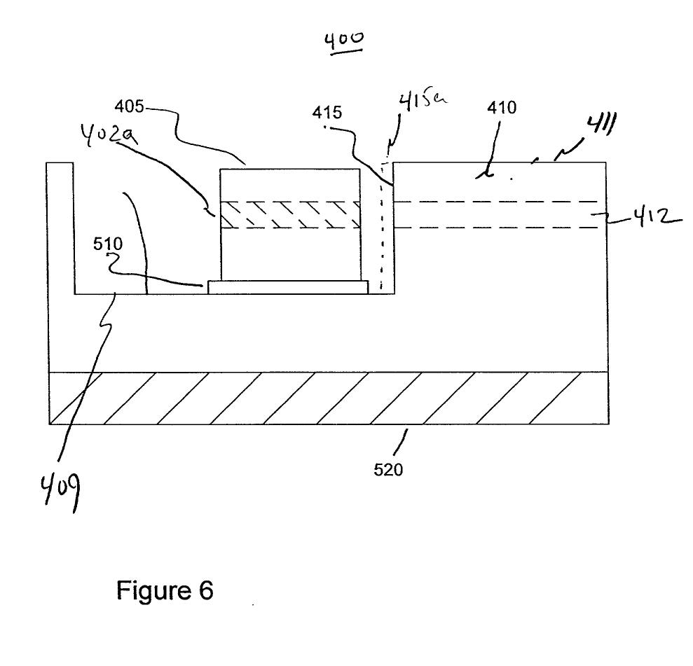

FIG. 6 illustrates a cross-sectional view of the integrated multiple wavelength pump laser module 400 illustrated in FIG. 5. In this illustration, it is more clearly shown the laser diode array 405 is positioned substantially oppositely opposed to corresponding waveguide input ports, which are contained in surface 415. As will be understood, laser diode array 405 is adjusted to maintain the laser active regions substantially oppositely opposed to a corresponding waveguide input port. In still another aspect of the invention, substantially perpendicular surface 415 is coated with an optically transparent anti-reflective material 415a.

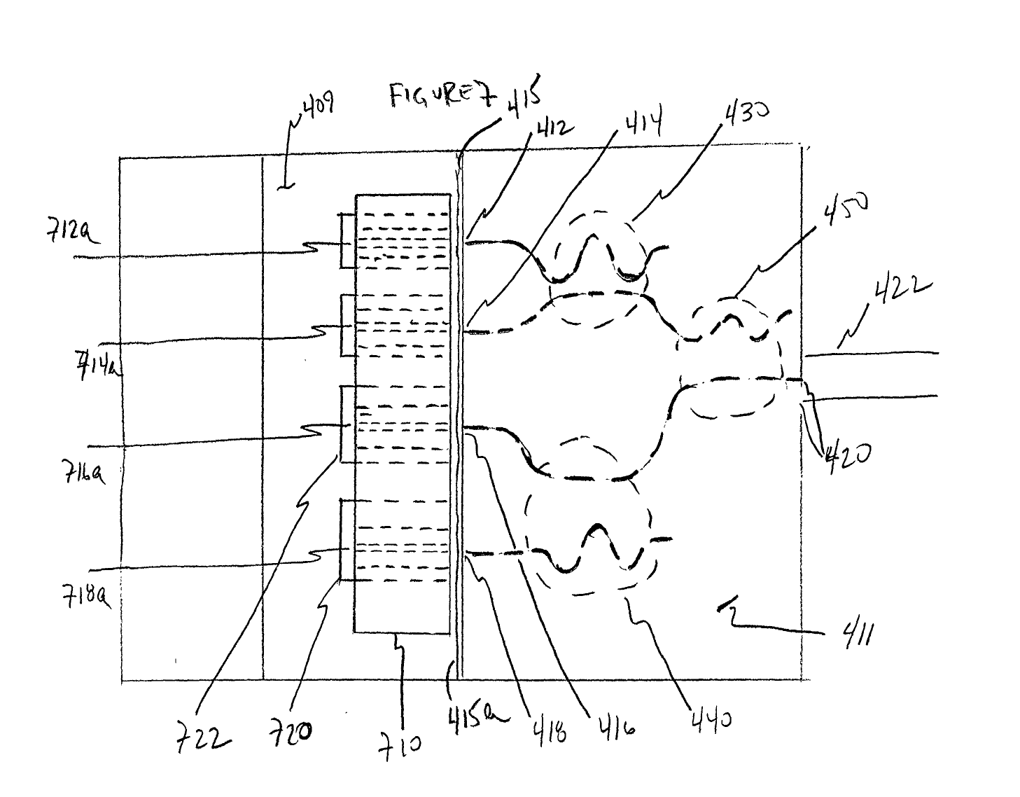

FIG. 7 illustrates a top view of another embodiment of the present invention. In this embodiment of the invention, a “U-shaped” well or groove having at least one substantially perpendicular side etched into base layer 410 and forms a first surface 409 in base layer 410 substantially perpendicular to the substantially perpendicular sides. Laser array 710 containing a plurality of laser diode active regions is located on first surface 409 and proximately located to at least one of the substantially perpendicular edges. For each laser diode active region within the laser array material 710, there is a corresponding pad of bonding material interposed between laser array 710 and first surface 409. In this illustrative case, bonding material elements 722, 720 are interposed between active region 716a, 718a, respectively, and first surface 409 such that the projection of active regions 716a, 718a onto first surface 409 are contained within the corresponding bonding material 722, 720. In a one embodiment, the individual pads of bonding material elements are in the order of ten times the width of a corresponding active region. Similarly, adjacent active regions may be combined into groups wherein each group has a single corresponding pad of bonding material. As would be appreciated bonding material 720, 722 are similar to bonding material 510 that was previously discussed.

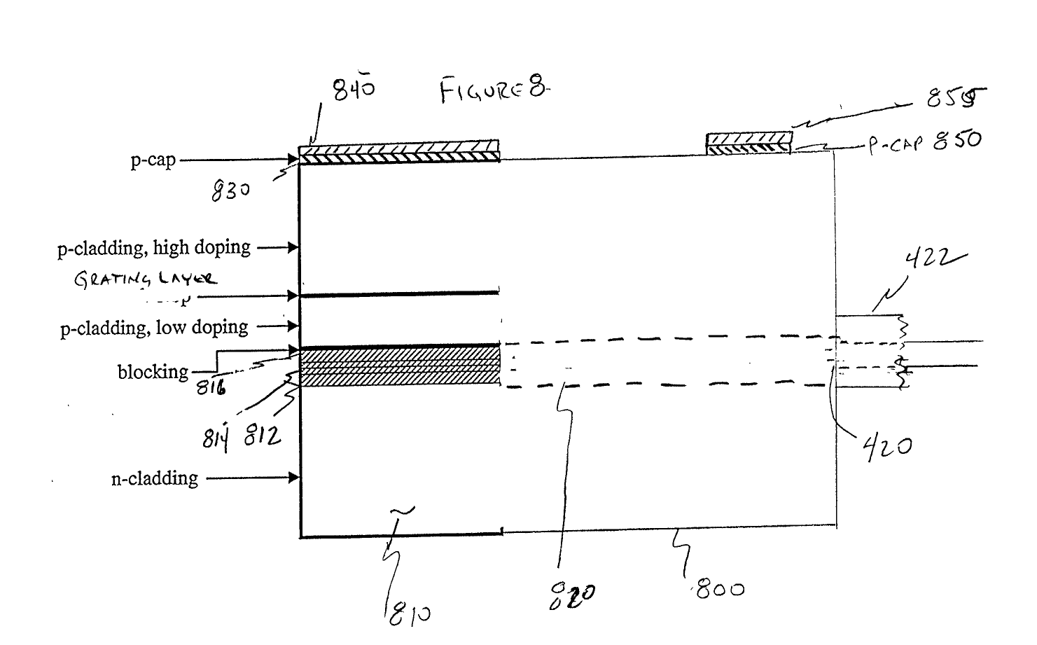

FIG. 8 illustrates a cross-sectional view of a integrated laser pump module 800 wherein laser array element 810 and corresponding wavelength multiplexer (WM), e.g., MZI, waveguide element 820 are concurrently fabricated within an electrooptical material, such as Indium Phosphate (InP). In this embodiment, DFB laser array elements are fabricated using known methods, which includes means for forming or growing a material layer on a surface by exposing the surface to the material. Other examples of known methods which can be used in accordance with the principles of the present invention are metal organic chemical deposition, molecular beam deposition, vapor deposition, thermal growth, oxidation and sputtering. In this illustrated example, a waveguide element 812 is fabricated grown on the substrate material. A laser active region 814 is next deposited on first waveguide 812. Concurrently, a WM waveguide 820 is fabricated or grown in the substrate a material such that the level of active region 814 and corresponding WM waveguide 820 are at substantially the same level. A second waveguide layer 816 is next deposited on active region 814. Accordingly, the lasing light generated by active region 814 is directed by waveguide elements 812, 816 into corresponding waveguide 820. Details regarding the continued fabrication or growth of the laser element illustrated are contained in commonly assigned PCT patent application serial number US01/02019, entitled “High Power Distributed Feedback Ridge Waveguide Laser,” filed on Jan. 22, 2001, previously referred-to.

A p-doped upper layer 830 is eventually grown on laser array 810 to provide an electrical contact to the fabricated laser element with laser array 810. Contact 840 is next selectively placed on p-doped layer 830 to provide electrical contact between laser array 810 and an electrical source (not shown) that provides a laser drive current. Contact 840 typically is a material having high electrical conductivity, such as Titanium Platinum Gold (TiPtAu).

In the region of the substrate material contain MZI waveguide 820, the p-doped layer is generally not deposited nor is an electrical contact made to the electrical source (not shown).

In another aspect of the invention, however, a p-doped layer 850 and electrical contact material 855 can be selectively placed within the region containing MZI waveguide 820 to provide amplification of signals within this region.

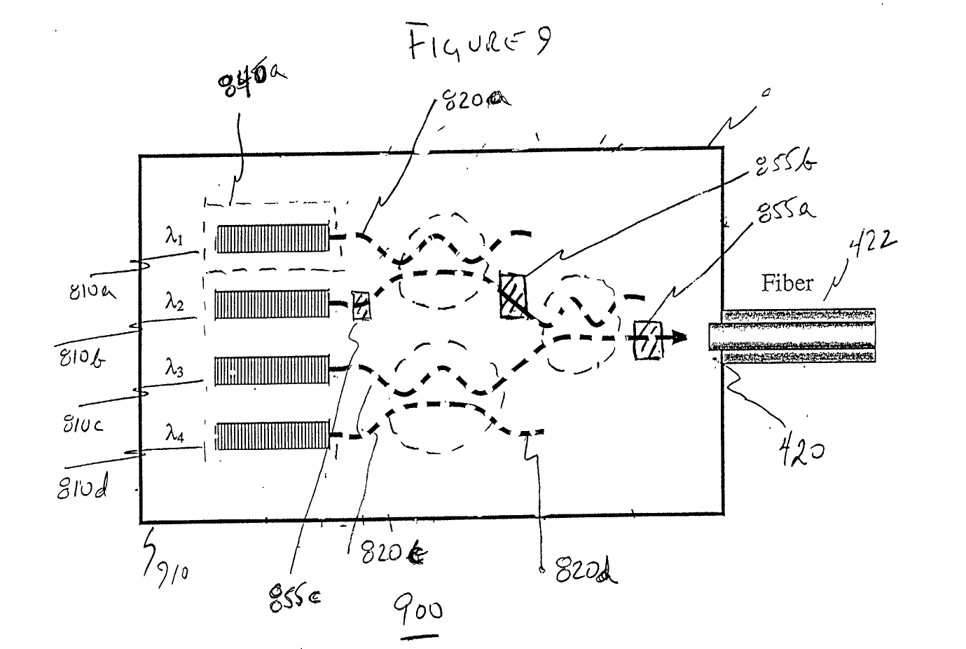

FIG. 9 illustrates a top view 900 of the integrated laser pump module depicted in FIG. 8. In this example, four laser elements 810a through 810d are fabricated and grown in substrate material 910. WM waveguide elements 820a through 820d are concurrently grown at a level that enables lasing energy from each of the fabricated lasers to enter a corresponding WM waveguide element. As previously disclosed the laser energy is combined by the combining effect of the WM elements to product a single laser output at port 420. Also illustrated are selectively placed electrical contacts 855a, 855b which are representative of contact points to provide electrical energy for amplifying portions of designated WM elements.

Although the invention has been described and pictured in a preferred form with a certain degree of particularity, it is understood that the present disclosure of the preferred form has been made only by way of example, and that numerous changes in the details of construction and combination and arrangement of parts may be made without departing from the spirit and scope of the invention as hereinafter claimed. It is expressly intended that all combinations of those elements and/or method steps which perform substantially the same function is substantially the same way to achieve the same results are within the scope of the invention. Substitutions of elements from one described embodiment to another are also fully intended and contemplated.

I claim:

1. An integrated laser pump module operable to combine a plurality of optical wavelengths, said module comprising:
a base layer having a first surface and a second surface and a substantially perpendicular surface therebetween, wherein said first surface and said second surface are in a step relation;
a plurality of waveguides fabricated in said base layer proximate said second surface interconnected in a known manner to produce a waveguide output, wherein each waveguide has a first end in said substantially perpendicular surface; and
a semiconductor laser array having a plurality of active regions located on said first surface and proximately located to said substantially perpendicular surface, wherein each active region is operable to emit a narrow spectra wavelength into a substantially oppositely opposed corresponding waveguide first end.

2. The module as recited in claim 1 further comprising:
a bonding material interposed between said laser array and first surface.

3. The module as recited in claim 2 wherein said bonding material is selected from the group: AuSn, PbSn, In.

4. The module as recited in claim 2 wherein said bonding material is dimensionally comparable with said laser array.

5. The module as recited in claim 2 wherein said bonding material comprises a plurality of elements, each of said elements corresponding to at least one selected laser active region, wherein said elements are position such that said at least one selected active region is contained within said corresponding element.

6. The module as recited in claim 1 further comprising:
a thermal cooling layer upon which said base layer is placed or deposited.

7. The module as recited in claim 1 wherein said laser array is composed of a plurality of semiconductor lasers.

8. The module as recited in claim 1 wherein said laser array is composed of a single material adapted to include a plurality of active regions.

9. The module as recited in claim 1 wherein said laser array is composed of a single material having a plurality of quantum wells of the same or differing widths.

10. The module as recited in claim 1 wherein said base layer is an optic-electronic material is selected from the group composed of InP, GaAS, Si, AlN.

11. The module as recited in claim 1 wherein said base layer is a material having a high thermal coefficient of expansion.

12. The module as recited in claim 1 wherein said base layer is a material having a coefficient of thermal expansion substantially similar to that of said laser array.

13. The module as recited in claim 1 wherein said selected at least one substantially perpendicular surface includes an anti-reflective coating.

14. The module as recited in claim 1 wherein said laser array is composed of DFB lasers.

15. The module as recited in claim 6 wherein said cooler is a thermo-electric cooler.

16. The module as recited in claim 1 wherein said waveguides are Mach-Zehnder Interferometers.

17. The module as recited in claim 1 wherein said waveguides are directional couplers.

18. An integrated laser pump module operable to combine a plurality of optical wavelengths onto a common waveguide output, said module comprising:
a base layer having a first surface and a second surface and at least one substantially perpendicular surface therebetween such that said first surface and said second surface are in a step relation, at least one of said substantially perpendicular surfaces includes an anti-reflective coating.
a plurality of waveguides contained within said base layer, proximate to said second surface, each of said waveguides having a first end and a second end wherein each of said first ends is located on said substantially perpendicular surface having said anti-reflective coating and each of said waveguide second ends interconnected in a manner to produce said common waveguide output;
a bonding material deposited on said first surface; and
a semiconductor laser array having a plurality of narrow spectra wavelength emitting active regions located on said bonding material and proximately located to said substantially perpendicular surface having said anti-reflective coating, wherein each active region substantially oppositely opposes a corresponding waveguide first end such that said emitted wavelength is directed toward a corresponding first end.

19. The module as recited in claim 18 further comprising:
a thermal cooling layer upon which said base layer is placed or deposited.

20. The module as recited in claim 18 wherein said laser array is composed of a plurality of semiconductor lasers.

21. The module as recited in claim 18 wherein said laser array is composed of a single semiconductor material adapted to include a plurality of active regions.

22. The module as recited in claim 18 wherein said laser array is composed of a single material having a plurality of quantum wells of the same or differing widths.

23. The module as recited in claim 18 wherein said bonding material is selected from the group: AuSn, PbSn, In.

24. The module as recited in claim 18 wherein said bonding material is dimensionally comparable with said laser array.

25. The module as recited in claim 18 wherein said bonding material comprises a plurality of mutually exclusive pads corresponding to at least one selected laser active region and positioned such that said at least one active region is contained within said corresponding pad.

26. The module as recited in claim 18 wherein said lasers are DFB lasers.

27. The module as recited in claim 19 wherein said cooler is a thermoelectric cooler.

28. The module as recited in claim 18 wherein said base layer is an optic-electronic material is selected from the group composed of InP, GaAs, Si, AlN.

29. The module as recited in claim 18 wherein said base layer is a material having a high thermal coefficient of expansion.

30. The module as recited in claim 18 wherein said base layer material has a coefficient of thermal expansion substantially similar to that of said laser array.

31. A high power integrated laser pump module comprising:
a base layer comprising:
a plurality of waveguides contained therein, each of said waveguides having a first end and a second end, wherein each waveguide is interconnected to an adjacent waveguide in a manner to produce a common waveguide output; and
a well, forming a first surface and at least one substantially perpendicular edge in said base layer and to said plurality of waveguide first ends, wherein said first ends are contained within one of said at least one substantially perpendicular well edge; and
a semiconductor laser array having a plurality of narrow spectra wavelength emitting active regions located on said first surface and proximately located to said substantially perpendicular surface containing said first ends, wherein each active region substantially oppositely opposes a corresponding waveguide first end.

32. The module as recited in claim 31 further comprising:
a bonding material interposed between said laser array and first surface.

33. The module as recited in claim 32 wherein said bonding material is selected from the group: AuSn, PbSn, In.

34. The module as recited in claim 32 wherein said bonding material is dimensionally comparable with said laser array.

35. The module as recited in claim 32 wherein said bonding material comprises a plurality of pads, each of said pads corresponding to at least one selected laser active region, wherein said pads are position such that said at least one selected active region is contained within said corresponding pads.

36. The module as recited in claim 31 further comprising:
a thermal cooling layer upon which said base layer is placed or deposited.

37. The module as recited in claim 31 wherein said laser array is composed of a plurality of semiconductor lasers.

38. The module as recited in claim 31 wherein said laser array is composed of a single material adapted to include a plurality of active regions.

39. The module as recited in claim 31 wherein said laser array is composed of a single material having a plurality of quantum wells of the same or differing widths.

40. The module as recited in claim 31 wherein said base layer is an optic-electronic material is selected from the group composed of InP, GaAS, Si, AlN.

41. The module as recited in claim 31 wherein said base layer is a material having a high thermal coefficient of expansion.

42. The module as recited in claim 31 wherein said base layer is a material having a coefficient of thermal expansion substantially similar to that of said laser array.

43. The module as recited in claim 31 wherein said substantially perpendicular surface containing said first ends includes an anti-reflective coating.

44. The module as recited in claim 31 wherein said laser array is composed of DFB lasers.

45. The module as recited in claim 36 wherein said cooler is a thermo-electric cooler.

46. The module as recited in claim 31 wherein said waveguides are Mach-Zendnder Interferometers.

47. The module as recited in claim 31 wherein said waveguides are directional couplers.

48. The module as recited in claim 31 wherein said plough is substantially “U-shaped.”

49. The module as recited in claim 31 wherein said plough is substantially “L-shaped.”

50. A high power integrated laser pump module comprising:
a base layer comprising:
a plurality of waveguides contained therein, each of said
waveguides having a first end and a second end, wherein each waveguide is interconnected to an adjacent waveguide in a manner to produce a common waveguide output; and
a semiconductor laser array having a plurality of narrow spectra wavelength emitting active regions adjacently located to a corresponding waveguide first end, wherein each active region substantially oppositely opposes a corresponding waveguide first end such that said emitted wavelength is directed toward a corresponding first end; and
a contact layer deposited on said base layer vertically disposed to said active regions.

51. The module as recited in claim 50 further comprising:
a thermal cooling layer upon which said base layer is placed or deposited.

52. The module as recited in claim 50 wherein said laser array is composed of a plurality of quantum wells of the same or differing widths.

53. The module as recited in claim 50 wherein said base layer is a semiconductor material selected from the group comprising: GaAs, InP, Si.

54. The module as recited in claim 50 wherein said laser array is composed of DFB lasers.

55. The module as recited in claim 50 wherein said cooler is a thermo-electric cooler.

56. The module as recited in claim 50 wherein said waveguides are Mach-Zehnder Interferometers.

57. The module as recited in claim 50 wherein said waveguides are directional couplers.

58. The module as recited in claim 50 wherein said contact layer is a p-doped semi-conductor material.

59. The module as recited in claim 50 wherein said contact layer is a material of high electrical conductivity.

60. The module as recited in claim 50 further comprising:
at least one second contact layer vertically deposited above selected portions of a corresponding waveguide.
